(19) United States
(12) Patent Application Publication
(10) Pub. No.: US 2026/0194804 A1
(43) Pub. Date: Jul. 9, 2026

(54) Assembly for a Camera System and Rear-View Device, Camera-Monitor System and Vehicle Therewith

(71) Applicant: Motherson Innovations Company Limited, London (GB)

(72) Inventors: Alexander Slama, Stuttgart (DE); Ralf Tiekenheinrich, Stuttgart (DE)

(21) Appl. No.: 19/441,052

(22) Filed: Jan. 6, 2026

(30) Foreign Application Priority Data
Jan. 9, 2025 (DE) 10 2025 100 632.6

(51) Int. Cl. G03B 30/00; H04N 23/54; H04N 23/55

(52) U.S. Cl. CPC G03B 30/00; H04N 23/54; H04N 23/55

(57) ABSTRACT

The present disclosure is directed towards an assembly for a camera system of a vehicle comprising at least one first lens tube adapted to support at least one first lens; at least one second lens tube adapted to support at least one second lens; a base plate configured to receive an imager, wherein the at least one first lens tube and the at least one second lens tube are configured to connect to the base plate; a mirror housing adapted to be formed by the at least one first lens tube, the at least one second lens tube or the base plate; and a mirror holder configured to secure a mirror; wherein the mirror holder is configured to slide into the mirror housing. It also relates to a rear-view device, a camera-monitor system, and a vehicle with such an assembly.

### CROSS-REFERENCE TO RELATED APPLICATIONS

This application claims priority to German Patent Application No. DE 10 2025 100 632.6, filed on Jan. 9, 2025, the entire contents of which are hereby incorporated by reference.

### BACKGROUND

The present disclosure relates to an assembly for a camera system of a vehicle as well as a rear-view device, a camera-monitor system, and a vehicle with such an assembly for a camera system.

A vehicle, such as a four-wheeled vehicle, is equipped with image-capturing devices like cameras to aid the driver in safely operating the vehicle. These cameras of the vehicle also provide valuable evidence during a forensic investigation of an accident, thereby helping in the determination of circumstances leading to the accident. Typically, cameras are strategically positioned in both the front and rear sections of the vehicle. In particular, to enhance the driver's visibility, cameras may be discreetly integrated into the vehicle's mirror assemblies located in the front section.

Camera units of vehicular image-capturing devices, which are equipped with two lenses associated with one camera, may have a reflective mirror which is usually placed inside the camera unit, as for example described in DE 10 2024 112 387. The reflective mirror is prone to break during the installation into the cameras and precautions should be taken while installation. Further, once the reflective mirror is installed, the reflective mirror is also subjected to dust and other contaminants which can reduce its efficiency. Therefore, the reflective mirrors are manually kept clean involving time, cost and manpower in maintaining the camera units.

U.S. Pat. No. 11,097,650 B2 discloses an integrated lamp-and-camera module including a pair of

license plate lamps that are disposed in a left-right direction of a license plate of a vehicle (VE), and apply light to the license plate; a first camera and a second camera that are disposed between the pair of license plate lamps to capture an image of a rear side of the vehicle; and a housing to which the respective license plate lamp, the first rear view camera, and the second camera are attached. However, U.S. Pat. No. 11,097,650 B2 fails to disclose any subject matter related to a mirror holder for securing a reflective mirror for the camera module.

Therefore, there is a need to provide a mirror holding structure with an enhanced geometrical configuration specifically designed for securing reflective mirrors in image-capturing devices installed in vehicles.

### SUMMARY

Hence, it is an object of the present disclosure to provide an assembly for a camera system of a vehicle, which overcomes at least partly the known drawbacks of the prior art. Particularly, it is the object to develop a cost-effective and enhanced mirror holding structure for a camera system of a vehicle.

The object is achieved by the features of the claim 1. Embodiments of the assembly for the camera system for a vehicle are described in claims 2 to 13.

The present disclosure describes an assembly for a camera system for use with a vehicle, comprising at least one first lens tube adapted to support at least one first lens, at least one second lens tube adapted to support at least one second lens, a base plate may be configured to receive an imager, wherein the at least one first lens tube and the at least one second lens tube may be configured to connect to the base plate. A mirror housing may be adapted to be formed by the at least one first lens tube, the at least one second lens tube or the base plate, and a mirror holder may be configured to secure a mirror. The mirror holder may be configured to slide into the mirror housing.

In an aspect, the base plate, the at least one first lens tube, the at least one second lens tube and the mirror housing may form a unitary structure. The unitary structure keeps tolerances in check while assembling the at least first lens tube and the at least second lens tube along with the base plate and the mirror housing in the assembly.

In an aspect, the mirror holder may comprise a first end comprising a shade portion extending in perpendicular direction to a plane AA of the mirror holder or the plane of the mirror attached to the mirror holder, and/or a second end configured to attach a sealing element.

The base plate may be adapted to have a secure opening at bottom of the base plate to insert the mirror holder into the mirror housing.

The mirror holder may be connected with the base plate by an adhesive. In an aspect, the assembly may further comprise a base frame, wherein the base plate is configured to be securely attached with the base frame, and/or the base frame extends from the base plate opposite the side from which the first and second lens tubes extend. The base plate may be configured to have a plurality of connecting elements adapted to be engaged with the base frame along with plurality of complementary connecting elements of the mirror housing and the imager.

In an aspect, the imager may be securely coupled on the base plate once the mirror holder is inserted into the mirror housing.

Further, the sealing element at the second end of the mirror holder may contact the imager after coupling of the imager with the base plate. Further, the base plate may be securely attached with a base frame.

In further aspect, the mirror housing may be oriented in the assembly at a predetermined angle from the base plate. The predetermined angle may be an acute angle.

In an aspect, the at least first lens may be adapted to project a first field of view and the at least second lens may be adapted to project a second field of view onto the imager.

The at least first lens may be adapted to project a first field of view on a first surface, and the at least second lens may be adapted to project a second field of view on a second surface of the imager. The ratio of first surface to the second surface, which determines the image resolution needed of the first and second field of view, may be adaptable, and/or the sizes of the first and second surfaces may be configured to be changed via the placement of the mirror.

In an aspect, the assembly may further comprise a plurality of connecting elements adapted to be engaged with a plurality of complementary connecting elements of the mirror housing.

The present disclosure is also related to a rear-view device, a camera-monitor system and a vehicle with an assembly for camera system as described above.

The foregoing summary is illustrative only and is not intended to be in any way limiting. In addition to the illustrative aspects, embodiments, and features described above, further aspects, embodiments, and features will become apparent by reference to the drawings and the following detailed description.

It should be understood that any one of the described features and/or embodiments of the disclosure may be used separately or in combination with other disclosed features and/or embodiments.

### BRIEF DESCRIPTION OF THE DRAWINGS

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

FIGS. 1A & 1B illustrate an embodiment of an assembly of a camera system with an aspect of the present disclosure, in a side and a cross-sectional view, respectively;

FIGS. 2A, 2B & 2C illustrate perspective front, cross-sectional side and top sectional views of a mirror holder of the assembly of FIGS. 1A and 1B, with an aspect of the present disclosure, respectively;

FIG. 3A illustrates a further perspective view of bottom of a base plate of the assembly of FIGS. 1A and 1B;

FIG. 3B illustrates a further side view of the mirror holder of FIGS. 2A to 2C when coupled with the assembly of FIGS. 1A and 1B; and

FIG. 4 illustrates a perspective front view of the mirror holder of FIGS. 2A to 2C when coupled with the assembly of FIGS. 1A and 1B.

The drawings referred to in this description are not to be understood as being drawn to scale except if specifically noted, and such drawings are only exemplary in nature.

### DETAILED DESCRIPTION

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

While the present disclosure is illustrated in the context of a four-wheeled vehicle, however, a holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

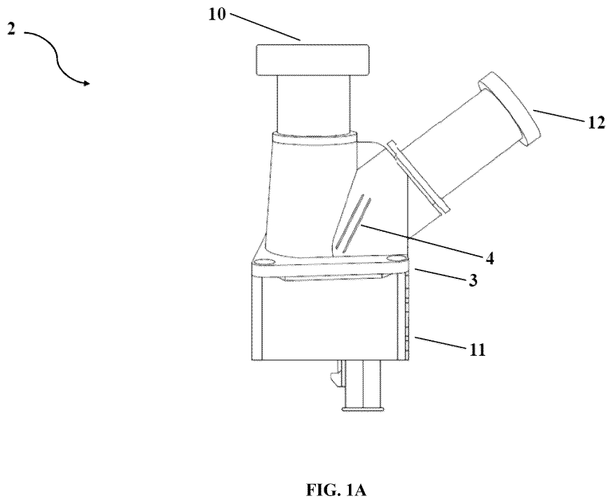

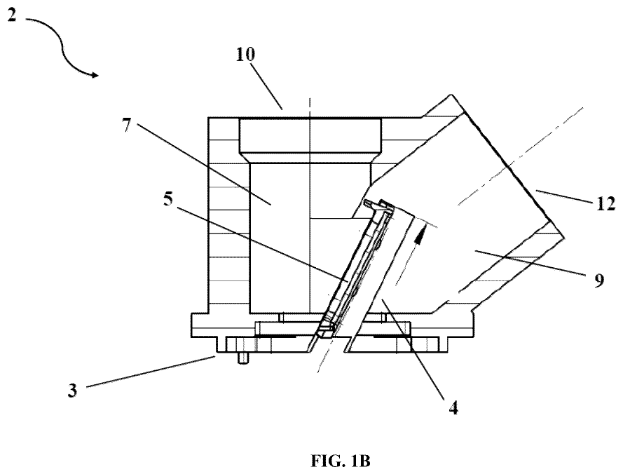

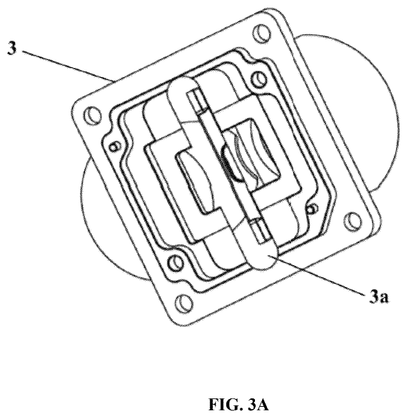

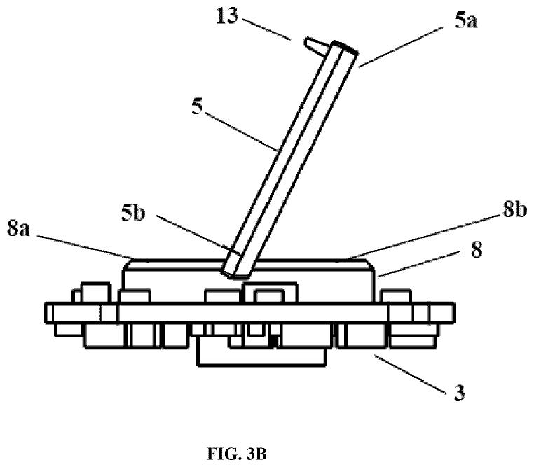

FIGS. 1A and 1B illustrate a side view and a cross-sectional view, respectively, of an assembly 2 of a camera system according to the present disclosure, in which two lenses 10, 12 may be integrated and adapted to project their field of views on one common imager 8 (as illustrated in FIG. 3B) and a mirror housing 4.

The camera system according to the said embodiment may comprise the assembly 2 with a base plate 3 between a base frame 11 and the two lenses 10, 12 as well as the mirror housing 4 therebetween. The base plate 3 may provide two seats adapted to support at least one first lens tube 7 and at least one second lens tube 9. The first and second lens tubes 7, 9 may be attached to the base plate 3.

In an embodiment, the mirror housing 4 may be formed by attachment of the first lens tube 7, and the second lens tube 9 may be formed by attachment to the base plate 3. The base plate 3 has a secure opening 3a (as illustrated in FIG. 3A) at the bottom that may be adapted for inserting a mirror holder 5 into the mirror housing 4.

In an embodiment, the mirror housing 4 may be oriented in the assembly at a predetermined angle from the base plate 3. Further, the predetermined angle may be an acute angle. A first end of the first and second lens tubes 7, 9 may be attached to the base plate 3, wherein an opposite, second end of the first and second lens tubes 7, 9 may be adapted to support the at least one first and at least one second lens 10, 12, respectively.

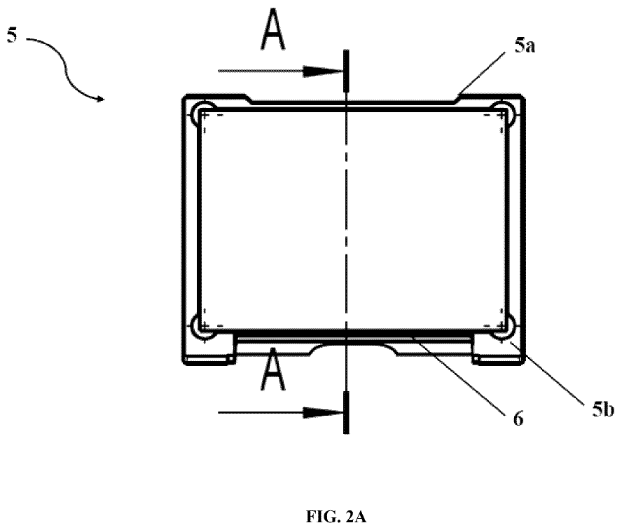

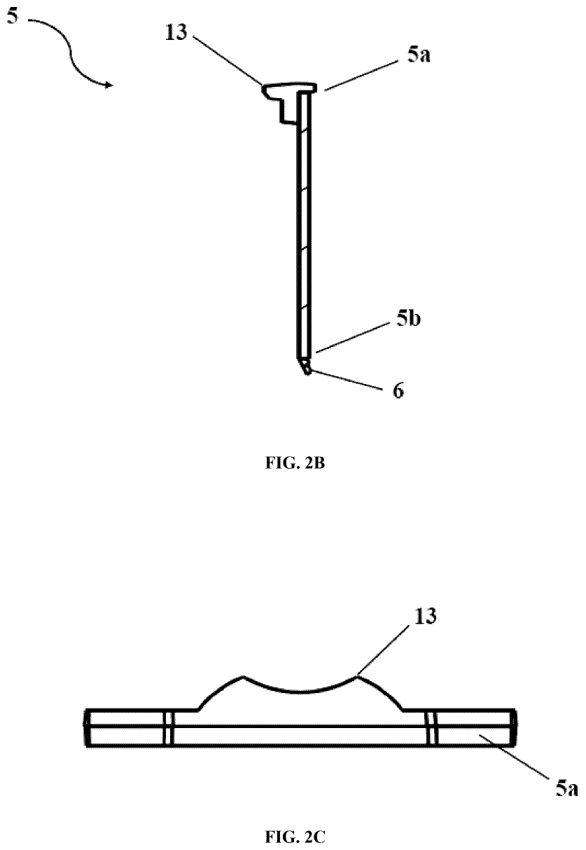

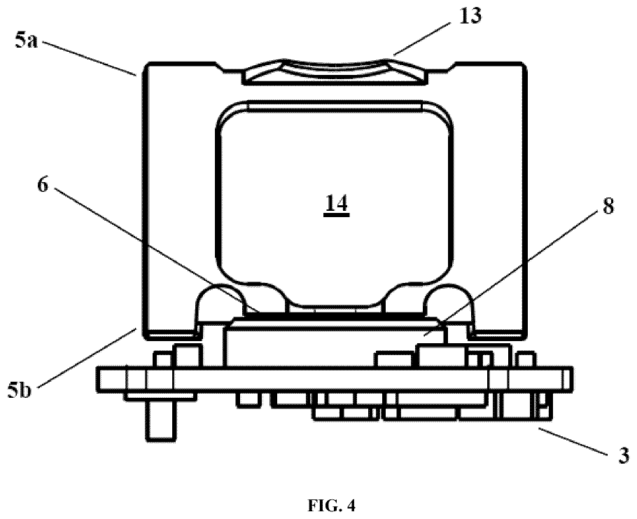

FIG. 2A illustrates a front view of the mirror holder 5 according to the present disclosure. The mirror holder 5 may have a first end 5a and a second end 5b. Further, the first end 5a may have a shade portion 13 (as illustrated in FIG. 2B and FIG. 2C) that extends in a perpendicular direction to plane A-A of the mirror holder 5 to protect a reflective mirror 14 to be attached to the holder 5 against stray light (with the reflective element 14 being shown in FIG. 4). Further, the shade portion may work as a Poka Yoke measure to prevent incorrect installation. The second end 5b of the mirror holder 5 may be configured to attach a sealing element 6. The mirror holder 5 may be configured to secure the reflective mirror 14 at the centre to provide support to the reflective mirror.

FIG. 2B illustrates a cross-sectional side view of the mirror holder 5 as illustrated in FIG. 2A. It can be seen from the figure that at the first end 5a of the mirror holder 5, the shade portion 13 may be extended in the perpendicular direction to the plane A-A.

FIG. 2C illustrates a top view of the mirror holder 5. In an embodiment, the shade portion 13 of the mirror holder 5 may be a Poka-Yoke shape for preventing installation error and fits into the mirror housing 4 once the mirror holder 5 is inserted. The shade portion 13 may further prevent the light from entering on either side of the first and second lens tube 10, 12.

In an embodiment, the base plate 3 may be configured to have the secure opening 3a as illustrated in FIG. 3A to insert the mirror holder 5 into the mirror housing 5 (as illustrated in FIG. 1B).

FIG. 3B illustrates an open view of the mirror holder 5 when coupled with the base plate 3 and the imager 8 as illustrated in the above figures. The imager 8 may be secured to the base plate 3 once the mirror holder 5 is inserted into the mirror housing 4. The imager 8 may be configured to have a first surface 8a and second surface 8b to receive a first field of view and a second field of view, respectively, received from the at least one first lens 10 and the at least one second lens 12.

As shown in the figure, the mirror holder 5 may be inserted in the mirror housing 4 and is configured to be coupled with the base plate 3.

The first field of view may be projected by the first lens 10 (as illustrated in FIG. 1B) to the first surface 8a of the imager 8, whereas the second field of view may be projected by the second lens 12 (as illustrated in FIG. 1B) to the second surface 8b of the imager 8. The optical axis of the first lens 10 may be substantially horizontal and perpendicular to the imager 8. The optical axis of the second lens 12 may be tilted. According to various embodiments the optical axis of the second lens 12 may be tilted towards the ground or towards a side or the back of a vehicle or its trailer (not shown). The first field of view is projected onto the first surface 8a of the imager 8 directly, whereas the second field of view is projected onto the second surface 8b of the imager 8 by means of the reflective mirror 14 secured to the mirror holder 5.

The ratio of first surface 8a to the second surface 8b may depend on the image resolution needed of the first and second field of view. The higher the resolution needed, the bigger may be the size of the imager 8 for the respective field of view. According to various embodiments, the sizes of the first and second surface 8a, 8b may be changed by an adaptable deflection mirror.

In an embodiment, the mirror holder 5, when inserted into the mirror housing 4, may be placed in a predetermined angle with the base plate 3. The predetermined angle at which the mirror holder 5 is placed may be an acute angle. The placement of the mirror holder 5 is such that the second end 5b of the mirror holder 5 having the sealing element 6, contacts the imager 8 coupled with the base plate 3.

In an embodiment, the base plate 3 may be configured to have a plurality of connecting elements adapted to be engaged with the base frame 11 (as illustrated in FIG. 1A) along with plurality of complementary connecting elements of the mirror housing 4 and the imager 8.

FIG. 4 illustrates a perspective front view of the mirror holder 5 as illustrated in FIG. 3B. As shown in the figure, the mirror holder 5 may have the first end 5a and the second end 5b. The first end 5a is configured to have the shade portion 13 and the second end 5b is configured to have the sealing element 6 securely attached. The base plate 3 is further configured to secure the imager 8. The imager 8 is secured to the base plate 3 once the mirror holder 5 is inserted into the mirror housing 4 (not shown in the figure). The sealing element 6 at the second end 5b of the mirror holder 5 may be in contact with the imager 8 after the mirror holder 5 is inserted into the mirror housing 4.

As already mentioned, the shade portion 13 of the mirror holder 5 may be a Poka-Yoke shape for preventing installation error and fits into the mirror housing 4 once the mirror holder 5 is inserted. Further, the shade portion 13 may also prevent any light or dust particles entering the mirror housing 4.

In an embodiment, the mirror holder 5 may provide support to the reflective mirror 14 when installed in the mirror housing 5.

As described above, although the embodiments are described by the limited embodiments and the drawings, various modifications and changes may be made by those skilled in the art from the above description. For example, appropriate results may be achieved even if the described techniques are performed in a different order than the described method, and/or components of the described system, structure, apparatus, circuit, etc. are combined or combined in a different form than the described method or replaced or substituted by other components or equivalents.

Therefore, other implementations, other embodiments of the present disclosure, and those equivalent to the claims also fall within the claims to be described below.

### REFERENCE SIGNS LIST

2 assembly
3 base plate
3a secure opening
4 mirror housing
5 mirror holder
5a first end of mirror holder
5b second end of mirror holder
6 sealing element
7 first lens tube
8 imager
8a first surface of imager
8b second surface of imager
9 second lens tube
10 first lens
11 base frame
12 second lens
13 shade portion
14 reflective mirror

What is claimed is:

1. An assembly for a camera system of a vehicle, comprising:
at least one first lens tube adapted to support at least one first lens;
at least one second lens tube adapted to support at least one second lens;
a base plate configured to receive an imager, wherein the at least one first lens tube and the at least one second lens tube are configured to connect to the base plate;
a mirror housing adapted to be formed by the at least one first lens tube, the at least one second lens tube or the base plate; and
a mirror holder configured to secure a mirror; wherein the mirror holder is configured to slide into the mirror housing.

2. The assembly according to claim 1, wherein the base plate, the at least one first lens tube, the at least one second lens tube and the mirror housing form a unitary structure.

3. The assembly according to claim 1, wherein the mirror holder comprises:
a first end comprising a shade portion, extending in perpendicular direction to a plane AA of the mirror holder or the plane of the mirror attached to the mirror holder; and/or
a second end configured to attach a sealing element.

4. The assembly according to claim 1, wherein the base plate is adapted to have a secure opening at its bottom to insert the mirror holder into the mirror housing.

5. The assembly according to claim 1, wherein the mirror holder is connected with the base plate, preferably by an adhesive.

6. The assembly according to claim 1, further comprising a base frame, wherein:
the base plate is configured to be securely attached with the base frame, and/or
the base frame extends from the base plate opposite the side from which the first and second lens tubes extend.

7. The assembly according to claim 6, wherein the base plate is configured to have a plurality of connecting elements adapted to be engaged with the base frame along with plurality of complementary connecting elements of the mirror housing and the imager.

8. The assembly according to claim 1, wherein the imager is configured to be securely coupled on the base plate once the mirror holder is inserted into the mirror housing.

9. The assembly according to claim 3, wherein the sealing element at the second end of the mirror holder is configured to contact the imager after attaching the imager with the base plate.

10. The assembly according to claim 1, wherein the mirror housing is oriented in the assembly at a predetermined angle from the base plate.

11. The assembly according to claim 10, wherein the predetermined angle is an acute angle.

12. The assembly according to claim 1, wherein:
the at least first lens is adapted to project a first field of view (FOV1) on a first surface of the imager, and
the at least second lens is adapted to project a second field of view (FOV2) on a second surface of the imager.

13. The assembly according to claim 12, wherein:
the ratio of first surface to the second surface, which determines the image resolution needed of the first and second field of view, is adaptable, and/or
the sizes of the first and second surfaces are configured to be changed via the placement of the mirror.

14. A rear-view device of a vehicle comprising at least one assembly for a camera system according to claim 1.

15. A camera-monitor device of a vehicle comprising at least one assembly for a camera system according to claim 1.

16. A vehicle comprising at least one assembly for a camera system according to claim 1.
